(19) United States
(12) Patent Application Publication
(10) Pub. No.: US 2003/0096073 A1
(43) Pub. Date: May 22, 2003

(54) Metalized label and the method of manufacture

(76) Inventors: Spencer L. Cser, Ione, CA (US); Douglas A. Lingo, Lockeford, CA (US)

Correspondence Address: Daniel J. Long, SAND & SEBOLT, Aegis Tower, Suite 1100, 4940 Munson Street N.W., Canton, OH, 44718, US

(21) Appl. No.: 09/990,147

(22) Filed: Nov. 21, 2001

(51) Int. Cl. B32B 7/06

(52) U.S. Cl. 428/40.1; 428/209; 156/277; 156/289

(57) ABSTRACT

A metalized label and a manufacturing method for the label. The label is made from a sheet material having a translucent plastic layer bonded to a metal layer. The metal layer has a reflective surface with a mirror-like finish which is visible through the plastic layer. Printed ink graphics and printed plastic raised graphics provide a three dimensional look and a texture to the upper surface of the sheet material. A translucent top film or sheet is bonded to the upper surface of the sheet material to protect the printed graphics from damage while preserving the look and texture provided by the raised graphics. The reflective surface provides a mirror-like background viewable through the plastic layer where not obscured by the ink graphics. An adhesive layer is applied to the lower surface of the sheet material, on the metal layer, for adhesive connection to a mounting surface. A backing sheet is temporarily adhered to the adhesive layer such that the label may be handled prior to application to the mounting surface.

### BACKGROUND OF THE INVENTION

1. Technical Field

The present invention relates generally to labels. More particularly the present invention relates to metalized labels, and methods for manufacturing such metalized labels having multiple layers.

2. Background Information

Metalized labels are known in industry which have graphical or textural indicia of a metallic appearance. Such labels are typically coated on the rear surface thereof with a layer of a pressure sensitive adhesive. A removable backing sheet temporarily covers the adhesive layer until application is desired to a mounting surface.

Metalized label according to the prior art typically include a translucent top cover sheet. A translucent base sheet is disposed below the cover sheet having a printed layer of graphics on the upper surface thereof. A metallic or metal layer is disposed below the translucent base sheet. The lower surface of the metal layer is coated with a layer of pressure sensitive adhesive. A removable backing sheet is removably adhered to the adhesive layer. The printed layer is visible through the translucent top cover sheet along with the metal layer which is additionally visible through the translucent base sheet, acting as the background for the printed layer. The translucent top sheet protects the printed layer from damage. Alternatively, a coating of varnish may be used in place of the top cover sheet to protect the printing.

The metalized labels are typically produced at a separate manufacturing facility from the label manufacturer. The metalized labels are manufactured from a laminated base sheet. The laminated base sheet is made by metalizing the rear surface of a continuous piece of base sheet using a vacuum metalizing device to form the metal layer. The bottom surface of the metal layer is coated with pressure sensitive adhesive to form an adhesive layer. A removable backing sheet is then applied to cover the adhesive layer for later removal prior to adhering the finished label to a mounting surface. The laminated base sheet is then wound into a roll for shipment to a label manufacturer.

At the label manufacturer's facility, the roll is unwound and passed through a printing device which prints the ink layer onto the front surface of the translucent base sheet. The ink graphics of the printed layer are applied only to selected portions of the translucent base sheet so as to leave unprinted areas through which the metal layer is visible. The translucent top cover sheet is then adhered to the front surface of the translucent base sheet, over the printed layer, to protect the printed graphics from damage. Alternatively, a varnish coating is applied to the front surface of the translucent base sheet over the printed layer to protect the printed graphics from damage.

The prior art metalized labels described above have the disadvantage of requiring both a translucent base sheet, and one or the other of a translucent cover sheet or varnish coating. This requirement adds expense and complexity to the metalized labels, and to the method of manufacturing the metalized labels. Also, the labels produced are relatively thick, heavy, and less flexible due to the number of layers required.

Attempts have been made to improve the traditional prior art metalized labels. One example is disclosed in U.S. Pat. No. 5,328,738 issued to McKillip et al. The metalized label disclosed therein has a translucent base sheet on the rear surface of which graphics are printed to form a printed layer. The graphics are printed in reverse image so as to appear properly when viewed from the front of the label through the translucent base sheet. The rear surface of the translucent base sheet is then metalized to form a metal layer over the printed graphics of the printed layer. The printed graphics form open areas and translucent areas through which the metal layer is visible when viewed from the front of the label. An adhesive layer is applied to the rear of the metal layer, and covered by a removable backing sheet.

The metalized label of McKillip et al. eliminates the need for a cover sheet or varnish coating to be used to protect the printed graphics of the printed layer. However, the label does not provide any improvements in the look and the feel over the traditional prior art metalized labels. It retains the same “flat” look and “smooth” feel of the prior art labels.

There is a need for a metalized label which has an improved, more three dimensional look, and a textured feel.

### SUMMARY OF INVENTION

1. Advantages of the Invention

One of the advantages of the present invention is that it provides a metalized label with an improved look, having a mirror-like background.

A further advantage of the present invention is it provides a metalized label with an improved look and feel, having printed raised areas which provide a three dimensional look and a textured feel.

Another advantage of the present invention is its ease of manufacturing the label using a commercially available laminated sheet material as the base material.

A further advantage of the present invention is the use of a top film which provides protection for the printed graphics while preserving the raised texture and flexibility of the label.

These and other advantages of the present invention may be realized by reference to the remaining portions of the specification, claims, and abstract.

The present invention comprises a metalized label for attachment to a mounting surface. The invention further comprises a method of manufacturing the metalized label.

The metalized label includes a layered sheet material having a translucent upper plastic layer bonded to a lower metal layer. The sheet material has an upper surface at the plastic layer, and a lower surface on the metal layer. One or more ink texts or graphics are printed on the upper surface of the sheet material. Preferably, one or more raised texts or graphics are also printed on the upper surface and the ink graphics. The metal layer has a reflective surface, preferably with mirror-like finish, to which the plastic layer is bonded. The reflective surface provides a reflective background which is viewable through the plastic layer and printed layer in at least a portion of the label. The label preferably further includes a translucent top film which is bonded to the upper surface of the sheet material, the ink graphics, and any raised graphics to protect the ink graphics and the raised graphics from damage. An adhesive layer is preferably provided which is adhered to the lower surface of the sheet material for adhering the label to a mounting surface. The adhesive sheet is covered by a removable backing sheet such that the label may be handled before application to the mounting surface.

The method of manufacturing the metalized label comprises a first step of providing a layered sheet material of the type having a translucent upper plastic layer bonded to a lower metal layer. The sheet material includes an upper surface on the plastic layer, and a lower surface on the metal layer. The metal layer has a reflective surface, preferably with a mirror-like finish, comprising a reflective background to which the plastic layer is bonded. A second step of the method comprises printing one or more ink graphics on the upper surface of the sheet material such that the reflective background is viewable through the plastic layer and printed layer in at least a portion of the label. The method preferably includes a further step of printing one or more raised graphics on the upper surface of the sheet material and the ink graphics such that the reflective background is viewable through the plastic layer and the printed layer in at least a portion of the label. Additional printing steps for the ink graphics and the raised graphics can be added to the method to obtain the desired visual and textural effects on the label. The method preferably includes further steps of providing a translucent top film, and bonding the top film to the upper surface of the sheet material, the ink graphics, and any raised graphics to protect the ink graphics and the raised graphics from damage. The method preferably includes further steps of applying an adhesive layer to the lower surface of the sheet material for adhering the label to a mounting surface. A backing sheet is provided, which is applied to the adhesive layer opposite the sheet material.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a front elevational view of a single label according to the invention;

FIG. 1A is substantially a lateral vertical sectional view taken on the line 1A-1A of FIG. 1 showing the layers of the label including a removable backing strip;

FIG. 2 is substantially a perspective view of a plurality of labels carried on the removable backing sheet as a roll;

FIG. 3 is substantially a perspective view of a layered roll of label material prior to printing and laminating;

FIG. 3A is substantially a lateral vertical sectional view taken on the line 3A-3A of FIG. 3 showing the various layers of the label material, comprising a sheet material such as a metalized polypropylene film, an adhesive layer, and a removable backing sheet;

FIG. 4 is substantially a diagrammatic illustration of a first step of a method for manufacturing the metalized labels according to the invention, wherein ink graphics are printed on the metalized polypropylene film such as by using a Flexographic printing process;

FIG. 4A is substantially a lateral vertical sectional view taken on the line 4A-4A of FIG. 4 showing the layers of the label material and the printed ink graphics on the metalized polypropylene film;

FIG. 5 is substantially a diagrammatic illustration of a second step of the method for manufacturing the metalized labels according to the invention, wherein raised graphics are printed on the metalized polypropylene film such as by using a Flexographic printing process;

FIG. 5A is substantially a lateral vertical sectional view taken on the line 5A-5A of FIG. 5 showing the layers of the label material, the printed raised graphics, and the printed ink graphics on the metalized polypropylene film;

FIG. 6 is substantially a diagrammatic illustration of a third step of the method for manufacturing metalized labels according to the invention,.wherein a translucent top film such as a clear polypropylene film is laminated over the printed raised graphics, the printed ink graphics, and the metalized polypropylene film; and

FIG. 6A is substantially a lateral vertical sectional view taken on the line 6A-6A of FIG. 6 showing the layers of the label material, the printed ink graphics, the printed raised graphics, and the laminated polypropylene film.

### DESCRIPTION OF THE PREFERRED EMBODIMENT

Referring to FIGS. 1 and 1A, therein is shown a metalized label construction 20 which includes a metalized label 23 and a backing sheet 26 temporarily adhered to the rear of label 23.

As viewed from the front in FIG. 1, label 23 includes one or more printed ink text or graphics 29 such as in the form of a bear 32 against a mirror-like background 35. Ink graphics 29 are printed using any of a number of standard translucent and opaque inks known in the printing industry. Background 35 has a polished metallic silver appearance like a mirror. Ink graphics 29 include opaque areas such as graphic 38 which is the line drawing of bear 32 printed with opaque ink. The background 35 does not show through such opaque areas. Other areas of ink graphics 29 are translucent to varying degrees such as translucent ink graphic 41 (crosslined areas) printed with a translucent ink within opaque graphic 38. The translucent ink might be tinted brown in color to appear metallic brown colored when viewed against background 35. Another translucent ink graphic 44 (non-crosslined area) is also printed within opaque graphic 38 using another translucent ink. The translucent ink might be tinted yellow in color to appear gold colored when viewed against background 35. The remainder 47 of background 35, outside bear 32, is unprinted such that the silver background shows through unaltered, though it could be printed with opaque or translucent ink.

As viewed from the front in FIG. 1, label 23 also includes one or more printed raised text or graphics 50 such as in the form of an outline 53 of bear 32, and a peripheral border 56 of label 23. Raised graphics 29 are printed using an air-drying or two-part curing liquid plastic or resin which is of a higher viscosity than standard inks so as to retain a raised profile upon printing. The liquid hardens or cures fairly rapidly under UV radiation to add a raised, three-dimensional look and a textured feel to label 23 unlike prior labels. Such a UV curable plastic may be purchased under the manufacturer's product number STX3RI which is manufactured by Northwest Coatings of Oak Creek, Wis. Raised graphics 50 can be clear (colorless), translucent (tinted), or opaque, depending on the desired look for the label.

As best shown in FIGS. 3 and 3A, label 23 is constructed from a layered sheet material 57 commercially available in the form of rolls 58. Sheet material 57 includes a metalized film or sheet material 59 comprising an translucent upper plastic layer 62 bonded to a lower metal layer 65. The plastic layer 62 can be topcoated with a clear or a translucent bonding agent (not shown) to aid in the adhesion and printability of ink thereon. The plastic, such as polypropylene, is preferably biaxially oriented for strength in multiple planar directions. Sheet material 57 includes respective upper and lower surfaces 66 and 67. A pressure sensitive adhesive layer 68 is applied to the lower surface 67 of sheet material 57 on metal layer 65. A backing sheet 71 is temporarily adhered to the adhesive layer 68 opposite metal layer 65 for removal prior to application of label 23 to the mounting surface of an article to be labeled.

Sheet material 57 is preferably 2 mil metalized polypropylene, manufacturer's product number PF8912, manufactured by MACTac Corporation, Stow, Ohio. This sheet material 57 uses an adhesive layer comprising an acrylic permanent adhesive, and a removable backing sheet which is a 3.2 mil super calendered kraft, release coated on the side which contacts the adhesive layer 68.

Printed ink graphics 29 are applied directly to plastic layer 62 opposite metal layer 65. Ink graphics 29 can be opaque and/or translucent, forming unprinted areas such as remainder 47 of background 35 through which the metal layer 65 is visible through plastic layer 62 essentially unaltered. Printed translucent areas such as translucent ink graphics 41 and 44 are where the metal layer 65 is visible but in an altered (tinted) form. Printed opaque areas such as line graphic 38 printed which outlines the bear 32 are where metal layer 65 cannot be viewed. Ink graphics 29 do not need to be printed in reverse to be properly legible as viewed from the front of label 23 as on some prior art labels wherein the ink graphics are printed on the opposite side of a plastic layer, against a metal layer.

Printed raised graphics 50 are applied over printed ink graphics 29 and plastic layer 62 to impart a three-dimensional look and a textured feel to label 23.

A translucent top film 74 is bonded to printed ink graphics 29, printed raised graphics 50, and plastic layer 62 such as by a heated lamination process. Top film 74 is heated and a vacuum drawn top film 74 onto printed ink graphics 29, printed raised graphics 50, and plastic layer 62 so as to conform and adhere thereto. This conforming of top film 74 to the irregular surface formed by printed ink graphics 29 and printed raised graphics 50 on plastic layer 62 transfers the three dimensional look and the textured feel to top film 74. Top film 74 is preferably clear polypropylene. Top film 74 protects printed ink graphics 29 and printed raised graphics 50 from being damaged during use of label 23.

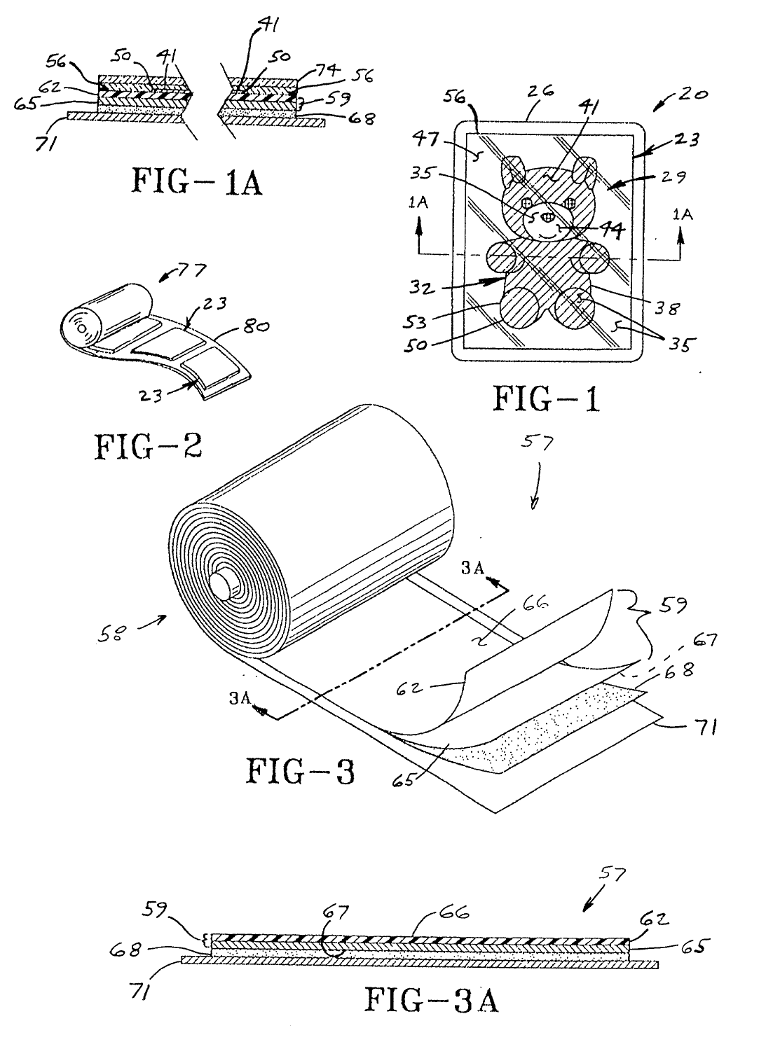

As shown in FIG. 2, a series of individual labels 23 may be die cut and provided in the form of a roll 77 carried on a continuous backing sheet 80. In roll form, the individual labels 23 may be conveniently applied to articles by automated labeling machinery.

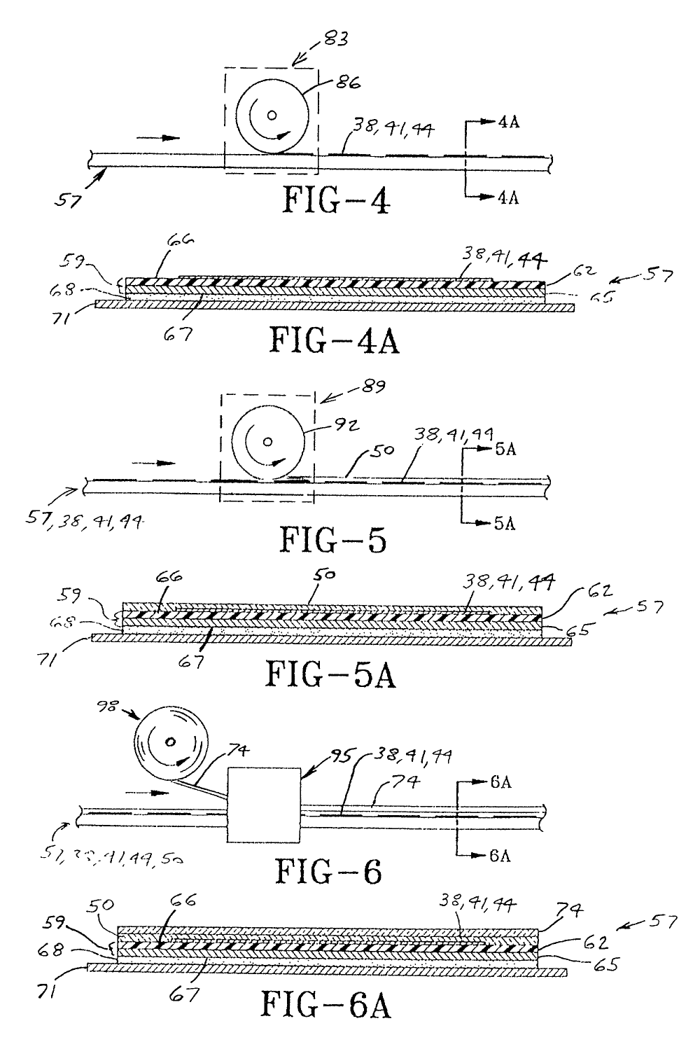

The manufacture of metalized labels 20 according to the invention is illustrated in FIGS. 4-6A.

As shown in FIGS. 3, 4 and 4A, layered sheet material 57 is unrolled such as from a roll 58 and passed through a printing device such as a rotary printer 83 with a rotatable print roller 86. Rotary printer 83 uses standard opaque and translucent inks, and the Flexographic printing process. The rotary printer 83 produces a series of individual printed ink graphics 29 along upper surface 66 of sheet material 57 on plastic layer 62 as print roller 86 makes contact therewith. Sheet material 57 may be provided in such a width that several longitudinally extending series of individual printed ink graphics 29 are printed side-by-side. The printed sheet material 57 is taken up on a takeup roll (not shown).

As shown in FIGS. 1 and 4A, the sheet material 57 now carries printed ink graphics 29 on plastic layer 62. Printed ink graphics 29 define the unprinted areas such as remainder 47 of background 35, through which the metal layer 65 is visible through plastic layer 62 essentially unaltered. Printed ink graphics 29 wherein tinted translucent ink is used form the printed translucent areas such as translucent ink graphics 41 and 44 wherein the metal layer is visible but in an altered, tinted form. Printed ink graphics 29 wherein opaque ink is used form the printed opaque areas such as graphic 38 which outlines the bear 32.

As shown in FIGS. 5 and 5A, the sheet material 57 carrying printed ink graphics 29 on upper surface 66 on plastic layer 62 is unrolled from the takeup roll (not shown) and passed through a second printing device such as a second rotary printer 89 with a rotatable print roller 92. Rotary printer 89 uses air-drying or two-part curing liquid plastic or resin, and the Flexographic printing process. The second rotary printer 89 produces a series of individual printed raised graphics 50 on printed ink graphics 29 on upper surface 66 of sheet material 57 on plastic layer 62 as print roller 92 makes contact therewith. The liquid plastic or resin is given sufficient time to air dry or cure so as to retain a raised profile before being taken up on a second takeup roll (not shown).

Thus, as shown in FIGS. 1 and 5A, the sheet material 57 now carries printed raised graphics 50 and printed ink graphics 29 on plastic layer 62 to impart a three-dimensional look and a textured feel to label 23.

As shown in FIGS. 3, 6 and 6A, the now printed sheet material 57 is unrolled from the second takeup roll (not shown) and passed through a laminating or bonding device such as heat laminating device 95, along with translucent top film 74 is unrolled such as from a roll 98. The top film 74 is bonded to printed ink graphics 29, printed raised graphics 50, and plastic layer 62 along the entire length of sheet material 57 including between the individual printed ink graphics 29. Top film 74 and the printed sheet material 57 are heated within heat laminating device 95 and forced into intimate contact such as by utilizing a vacuum or a cushioned pinching roller arrangement (not shown) so as to adhere the two together without air bubbles therebetween and without permanently flattening the printed raised graphics appreciably. The heating softens top film 74 so as to allow conforming to the irregular surface formed by printed ink graphics 29 and printed raised graphics 50. The printed and laminated sheet material 57 is taken up on a takeup roll (not shown) to form roll 77 having a series of individual labels 23.

The now printed and laminated sheet material 57 is cut into individual labels 23 such as for hand assembly to articles. If the individual labels are to be used on automated labeling machinery, the cut backing sheet 71 is removed from the individual labels 23 and assembled to continuous backing sheet 80 to form rolls 77 (FIG. 2).

The cutting of the individual labels 23 and assembling to a continuous backing sheet 80 is well known in the label industry and thus will not be explained in detail. The cutting involves passing the printed and laminated sheet material 57 through a die cutter (not shown) which cuts through the top film 74 and backing sheet 71 of sheet material to form the discrete, individual labels 23 on individual backing sheets 71. Backing sheet 71 can be removed from the now die cut labels 23 and replaced with a continuous backing sheet 80 to form a roll 77 as shown in FIG. 2.

If multiple longitudinally extending series of labels laterally disposed on backing sheet 71 are produced as described above, a slitter (not shown) may be used along with the die cutter to separate the backing sheet 71 into multiple longitudinally extending series of individual labels 23. The slit backing sheets can be removed and replaced with respective continuous backing sheets similar to continuous backing sheet 80, to form respective rolls similar to roll 77 carrying a single series of labels 23.

It can now be seen that the present invention solves many of the problems associated with the prior art. The present invention provides a metalized label with an improved look, having a mirror-like background. The present invention further provides a metalized label having an improved look and feel, having printed raised areas which provide a three dimensional look and a textured feel. The present invention further provides a metalized label which is easier to manufacture due to using a commercially available laminated sheet material as the base material. The present invention still further provides a top film which protects the printed graphics while preserving the raised texture of the label.

Although the description above contains many specifications, these should not be construed as limiting the scope of the invention but as merely providing illustrations of some of presently preferred embodiments of this invention. The specification, for instance, makes reference to the use of polypropylene sheets and film. However, the present invention is not intended to be limited only to polypropylene. Rather, any suitable translucent or clear plastic material, including other polymeric materials such as polystyrene, polyethylene, polyester, or acrylic can be used. Polyester has good heat resistance for applications requiring such, and is available from Dupont under the trademark MYLAR or from I.C.I. under the trademark MELINEX.

The specification makes reference to polypropylene film of a thickness of about 2 mil, including the metal layer. However, the thickness of the polymeric film is not critical so long as flexibility, preserving of the texture imparted by the raised graphics, and good contouring properties are obtained. The preferred range is between about (0.00025 to 0.020) inch thick.

The specification makes reference to the metal layer completely covering the plastic layer of the sheet material. However, if the printed graphics of the labels are arranged suitably, it is not necessary to use sheet material in which the metal layer completely covers the plastic layer. Rather, the metal layer can lie in registration with the open areas where no opaque ink graphics are present, or where translucent graphics are present (i.e. where the metal background is visible).

The specification also makes reference to the metal layer, but not the particular type of metal. The metal layer can be most any metal which has a metallic reflectiveness and which can be coated or deposited on the plastic film such as polymeric film, or dispersed thereon by other known procedures. Such metals are for example, aluminum, chromium, zinc, copper, silver, or gold. The thickness of the metal layer should be such as to provide good reflectivity. The preferred optical density in the visible spectrum is from between about 2.3 and 2.8.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A label, comprising:
a layered sheet material having a translucent upper plastic layer bonded to a metal layer, said sheet material having an upper surface on said plastic layer and a lower surface on said metal layer;
an ink graphic printed on said upper surface; and
wherein said metal layer has a reflective surface to which said plastic layer is bonded, said reflective surface comprising a reflective background which is viewable through said plastic layer in at least a portion of the label.

2. The label of claim 1, wherein the reflective surface has a mirror-like finish.

3. The label of claim 2, wherein the ink graphic is printed using an opaque ink such that the reflective background is not visible through said ink graphic.

4. The label of claim 2, wherein the ink graphic is printed using a tinted translucent ink such that the reflective background is visible through said ink graphic in a tinted form.

5. The label of claim 4, wherein a second ink graphic is printed using an opaque ink such that the reflective background is not visible through said second ink graphic.

6. The label of claim 1, wherein the ink graphic is printed using an opaque ink such that the reflective background is not visible through said ink graphic, and wherein a raised graphic is printed on the upper surface of the sheet material with said ink graphic.

7. The label of claim 1, wherein the ink graphic is printed using a tinted translucent ink such that the reflective background is visible through said ink graphic in a tinted form, and wherein a raised graphic is printed on the upper surface of the sheet material with said ink graphic.

8. The label of claim 7, wherein the ink graphic is printed using an opaque ink such that the reflective background is not visible through said ink graphic.

9. The label of claim 1, further comprising a translucent top sheet which is bonded to the upper surface of the sheet material with the ink graphic to protect said ink graphic from damage.

10. The label of claim 9, wherein the reflective surface has a mirror-like finish.

11. The label of claim 10, wherein the ink graphic is printed using an opaque ink such that the reflective background is not visible through said ink graphic.

12. The label of claim 10, wherein the ink graphic is printed using a tinted translucent ink such that the reflective background is visible through said ink graphic in a tinted form.

13. The label of claim 12, wherein the ink graphic is printed using an opaque ink such that the reflective background is not visible through said ink graphic.

14. The label of claim 9, wherein the ink graphic is printed using a tinted translucent ink such that the reflective background is visible through said ink graphic in a tinted form, and wherein a raised graphic is printed on the upper surface of the sheet material with said ink graphic.

15. The label of claim 14, wherein the ink graphic is printed using an opaque ink such that the reflective background is not visible through said ink graphic.

16. The label of claim 9, further comprising an adhesive layer adhered to the lower surface of the sheet material such that the label is adapted to be adhered to a mounting surface.

17. The label of claim 16, further comprising a backing sheet temporarily adhered to the adhesive layer opposite the sheet material such that the label may be handled before application thereof to the mounting surface.

18. A method of manufacturing a label, comprising the steps of:
providing a layered sheet material having a translucent upper plastic layer bonded to a metal layer, the sheet material having an upper surface on the plastic layer and a lower surface on the metal layer, the metal layer having a reflective surface to which the plastic layer is bonded comprising a reflective background; and
printing an ink graphic on the upper surface of the sheet material such that the reflective background is viewable through the plastic layer and in at least a portion of the label.

19. The method of claim 18, wherein the reflective surface of the layered sheet material used has a mirror-like finish.

20. The method of claim 19, wherein the ink graphic is printed using an opaque ink such that the reflective background is not visible through the ink graphic.

21. The method of claim 19, wherein the ink graphic is printed using a tinted translucent ink such that the reflective background is visible through the ink graphic in a tinted form.

22. The method of claim 21, wherein a second ink graphic is printed using a second, opaque ink such that the reflective background is not visible through the second ink graphic.

23. The method of claim 18, further comprising a step of printing a raised graphic on the upper surface with the ink graphic of the sheet material such that the reflective background is viewable through said plastic layer and over at least a portion of the label after printing.

24. The label of claim 18, further comprising the steps of:
providing a translucent top film; and bonding the translucent top film to the upper surface of the sheet material with the ink graphic to protect the ink graphic from damage.

25. The method of claim 24, further comprising a step of printing a raised graphic on the upper surface of the sheet material with the ink graphic such that the reflective background is viewable through the plastic layer in at least a portion of the label.

26. The method of claim 24, further comprising a step of applying an adhesive layer to the lower surface of the sheet material such that the label is adapted to be adhered to a mounting surface.

27. The method of claim 26, further comprising the steps of:
providing a backing sheet; and
applying the backing sheet to the adhesive layer opposite the sheet material, which backing sheet is temporarily adhered to the adhesive layer such that the label may be handled before application thereof to the mounting surface.

28. The method of claim 24, further comprising the step of die-cutting the labels to provide finished labels of a desired shape and size.

29. The method of claim 24, wherein multiple labels are printed as multiple longitudinally extending series of labels, and further comprising of step of slitting the layered sheet into a plurality of sheets each carrying a single longitudinally extending series of labels.
